(19) United States
(12) Patent Application Publication
(10) Pub. No.: US 2009/0135443 A1
(43) Pub. Date: May 28, 2009

(54) IMAGE FORMING APPARATUS AND METHOD

(75) Inventors: Kunihiro TAKAHASHI, Ashigarakami-gun (JP); Mario FUSE, Ashigarakami-gun (JP); Tsukasa MATSUDA, Ebina-shi (JP); Eizo KURIHARA, Ebina-shi (JP); Shoji YAMAGUCHI, Ashigarakami-gun (JP); Hiroyoshi INOUE, Ashigarakami-gun (JP); Yasunori KODA, Ashigarakami-gun (JP); Ivutin DMITRY, Ebina-shi (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/276,892

(22) Filed: Nov. 24, 2008

Related U.S. Application Data
(63) Continuation-in-part of application No. 12/173,474, filed on Jul. 15, 2008, now abandoned.

(30) Foreign Application Priority Data
Nov. 27, 2007 (JP) 2007-305891
Sep. 18, 2008 (JP) 2008-239095

(51) Int. Cl. G06K 15/00; H04N 1/00

(52) U.S. Cl. 358/1.14; 358/401

(57) ABSTRACT

An image forming apparatus includes an image reading unit that reads an image formed on a recording medium; a copy-prohibited medium detecting unit that detects whether a recording medium is a copy-prohibited medium; and a controller that controls to disable or inhibit copying of an image formed on a recording medium, when it is detected by the copy-prohibited medium detecting unit that the recording medium is the copy-prohibited medium, before the image on the recording medium is read by the image reading unit.

### CROSS-REFERENCE TO RELATED APPLICATIONS

This application is based on and claims priority under 35 USC 119 from Japanese Patent Application Nos. 2007-305891 filed Nov. 27, 2007 and 2008-239095 filed Sep. 18, 2008.

This application is a continuation-in-part of U.S. patent application Ser. No. 12/173,474, the entire contents of which are hereby incorporated by reference.

### BACKGROUND

1. Technical Field

The present invention relates to image forming apparatus with a document reading function such as a complex machine and method for forming image.

2. Related Art

To prevent information leakage is important in using an image forming apparatus of this nature. For the purpose of preventing information leakage, such a method is publicly known that, when, for example, a copy-prohibited document page is read by a scanner or the like, detects a specific pattern from the read page image and controls output according to the detected pattern.

### SUMMARY

According to an aspect of the invention, there is provided an image forming apparatus including: an image reading unit that reads an image of a recording medium; a copy-prohibited medium detecting unit that detects a recording medium prohibited from being copied; and a controller that controls to disable or inhibit copying of the recording medium, when it is detected that the recording medium is copy-prohibited by the copy-prohibited medium detecting unit before the image of the recording medium is read by the image reading unit.

### BRIEF DESCRIPTION OF THE DRAWINGS

Exemplary embodiments of the present invention will be described in detail based on the following figures, wherein:

FIG. 1 illustrates an image forming apparatus 10 according to an exemplary embodiment of the invention;

FIG. 2 illustrates a detailed structure of an automatic document feeding device 44 of the image forming apparatus 10 according to a first exemplary embodiment of the invention;

FIG. 3 illustrates a configuration of a controller 60 of the image forming apparatus 10;

FIG. 4 is a flowchart illustrating an overall operation (S10) of the image forming apparatus 10 according to a first exemplary embodiment of the present invention;

FIG. 5 illustrates a detailed structure of the automatic document feeding device 44 of the image forming apparatus 10 according to a second exemplary embodiment of the invention;

FIG. 6 illustrates a detailed structure of the automatic document feeding device 44 of the image forming apparatus 10 according to a third exemplary embodiment of the invention;

FIG. 7 is a view illustrating a detailed configuration of the automatic document feeding device 44 of the imaging forming apparatus 10 according to a fourth exemplary embodiment of the present invention; and

FIG. 8 is a flowchart illustrating an overall operation (S20) of the imaging forming apparatus 10 according to the fourth exemplary embodiment of the present invention.

### DETAILED DESCRIPTION

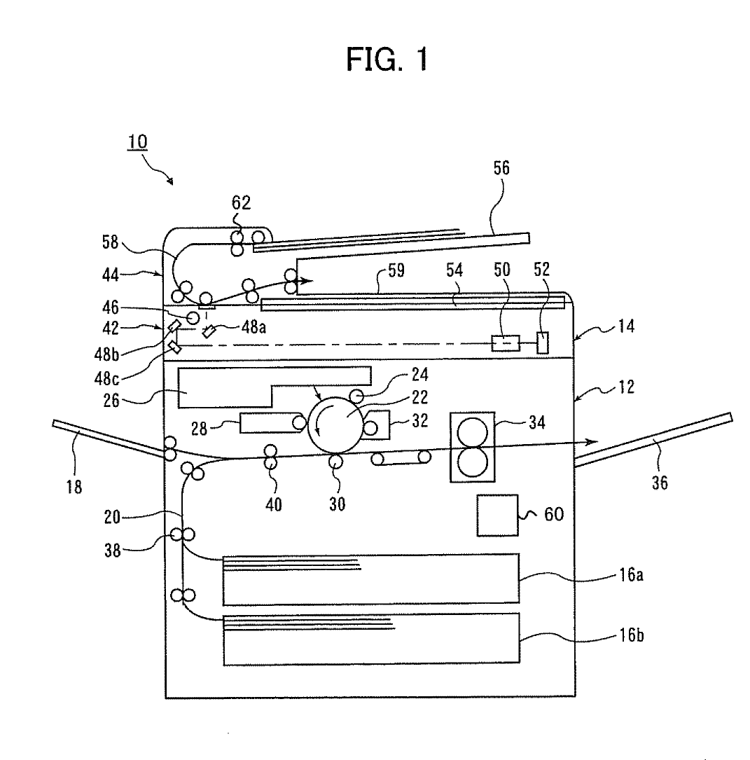

FIG. 1 illustrates an image forming apparatus 10 according to an exemplary embodiment of the present invention.

As shown in FIG. 1, the image forming apparatus 10 includes an image forming part 12 which is, e.g., an electrophotographic device, a document reading device 14, sheet feed trays 16a, 16b in, e.g., two tiers in which sheets are stacked, a manual feed tray 18, and a controller 60. The image forming apparatus 10 is, for example, a multifunction machine with printing, copying, and reading functions. An image read by the document reading device 14 or an image rendered based on print data transmitted from a remote terminal device (not shown) is produced on a sheet fed through onto a sheet transport path 20 from one of the sheet feed trays 16a, 16b or the manual feed tray 18.

The image forming part 12 includes an image carrier 22, a charger which charges the image carrier 22 evenly, an exposure device 26 which forms a latent image on the image carrier 22 evenly charged by the charger 24, a development device 28 which makes the latent image formed by the exposure device 26 on the image carrier 22 visible by toner, a transfer device 30 which transfers a toner image formed by the development device 28 onto a sheet, and a cleaner 32 which clears remaining toner particles from the image carrier 22. The exposure device 26 is, for example, of a laser scan type and outputs laser on/off signals corresponding to image data obtained by reading an image. The transfer device 30 is formed of, e.g., a transfer roller. A sheet having a toner image transferred thereto by the transfer device 30 is conveyed to a fixing device 34. The toner image is fixed onto the sheet by the fixing device 34 and the sheet having the toner image fixed thereto is ejected to an output tray 36.

On the sheet transport path 20, plural pairs of transport rollers 38 are arranged. As one of the pairs of transport rollers 38, a pair of registration rollers 40 is disposed near to and upstream of the transfer device 30. The registration rollers 40 are controlled to once stop a sheet being transported and supply it to the transfer device 30 in synchronization with a timing when a latent image is formed on the image carrier 22.

The document reading device 14 includes an optical system 42 (image reading unit) which optically reads a page image and an automatic document feeding device 44 such as an ADF (Automatic Document Feeder) The optical system 42 includes a lamp 46 which emits light to irradiate a page, reflecting mirrors 48a, 48b, 48c, a lens 50 which converges light from the reflecting mirrors 48a to 48c, and a reading sensor 52 which reads light converged by the lens 50. The reading sensor is formed of, e.g., a CDD. The optical system 42 has a function to scan a document page transported by the automatic document feeding device 44 which will be described later and a function to read a document page placed on a platen glass 54 by scanning the reflecting mirrors 48a to 48c, etc. A document is composed of a recording medium such as a paper sheet and an image recorded thereon.

The automatic document feeding device 44 includes a document mount 56 on which multiple-page documents are placed, a document transport path 58, transport rollers 62 for transporting a document page, and a receiving plate 59 onto which a document page whose image has been read is ejected. The automatic document feeding device 44 is openable and closeable and the under surface of the automatic document feeding device 44 functions as a platen cover that presses a document page against the platen glass 54.

The image forming apparatus 10 may be of a tandem type or a rotary type. The image forming part 12 may be implemented as other types such as an ink jet type.

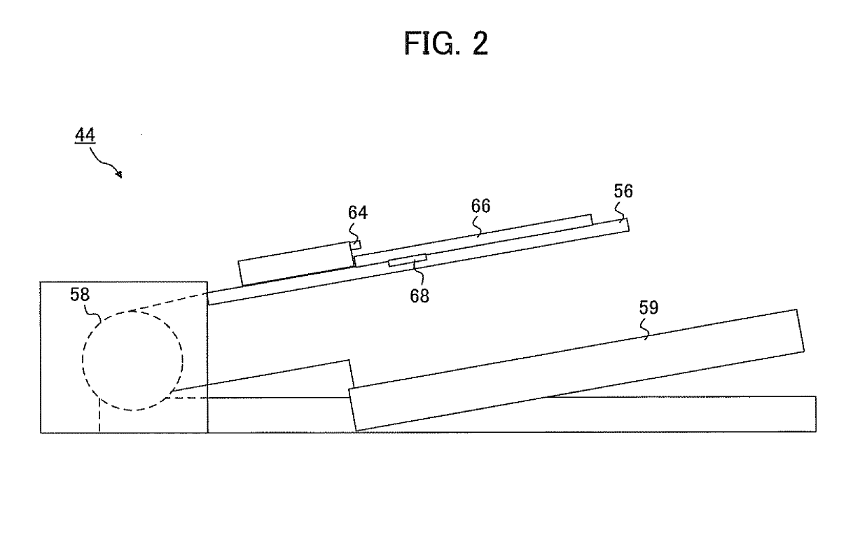

FIG. 2 illustrates a detailed structure of the automatic document feeding device 44 of the image forming apparatus 10 according to a first exemplary embodiment of the invention.

As shown in FIG. 2, the automatic document feeding device 44 is equipped with a document page detecting sensor 68 which detects document pages placed on the document mount 56, a copy-prohibited medium detecting sensor 66 which detects a copy-prohibited medium among the document pages detected by the document page detecting sensor 68, and also a trail edge detecting sensor 64 which detects the trail edge of a document page being transported from the document mount 56 onto the document transport path 58.

In the automatic document feeding device 44, the document page detecting sensor 68 is, e.g., a reflective optical sensor including a light emitting device and a light receiving device. Upon detecting reflected light, the document page detecting sensor 68 outputs a document page detection signal indicating that a document page has been placed to the controller 60 which will be described late. The trail edge detecting sensor 64 is also a reflective optical sensor like the document page detecting sensor 68. Upon detecting the trail edge of a document page, the trail edge detecting sensor 64 outputs a trail edge detection signal to the copy-prohibited medium detecting sensor 66.

The copy-prohibited medium detecting sensor 66, which is provided on the document mount 56, is a sensor that detects a change in a produced magnetic field. The copy-prohibited medium detecting sensor 66 is, e.g., a clip antenna with dimensions, approximately, 298 mm×55 mm, and detects a copy-prohibited document page with the aid of a large Barkhausen effect. More specifically, when a document page whose recording medium is embedded with a magnetic element such as a magnetic wire exhibiting the large Barkhausen effect is placed on the document mount 56, the copy-prohibited medium detecting sensor 66 detects magnetization inversion induced by the magnetic element included in the recording medium of the document page and outputs a signal (copy prohibition signal) indicating that a copy-prohibited medium has been detected to the controller 60. In this case, the copy-prohibited medium detecting sensor 66 outputs the copy prohibition signal as a set signal for a flip-flop operation.

When the copy-prohibited medium detecting sensor 66 outputs a copy prohibition signal, it stops the output of the copy prohibition signal by a reset operation upon the elapse of a predetermined period of time after receiving a trail edge detection signal from the trail edge detecting sensor 64 and then returns to a state that it is able to detect another copy-prohibited medium. For example, upon the elapse of a time period that is enough for CPU 100 to bring the ongoing reading operation to a stop after the copy-prohibited medium detecting sensor 66 receives a trail edge detection signal, the reset operation of the copy-prohibited medium detecting sensor 66 takes place. The copy-prohibited medium detecting sensor 66 may be reset by the controller 60.

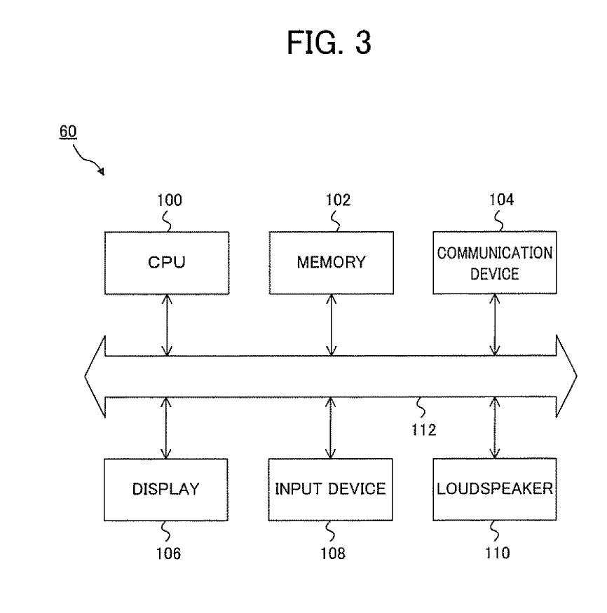

FIG. 3 illustrates a configuration of the controller 60 of the image forming apparatus 10.

As shown in FIG. 3, the controller 60 includes a CPU 100, a memory 102, a communication device 104 for data communication with a remote terminal device or the like, a display 106 such as a liquid crystal display, an input device 108 such as a keyboard, and a loudspeaker 110 for audio output. These components are connected via a bus 112. The display 106 and the input device 108 may be implemented as a touch panel.

The CPU 100 (controller) executes a prearranged program and controls other components of the image forming apparatus 10 If it is detected by the copy-prohibited medium detecting sensor 66 that a recording medium of a document is prohibited from being copied before the image of the document is read by the optical system 42, the CPU 100 controls to disable or inhibit copying of this image. More specifically, if the CPU 100 receives the input of a copy prohibition signal output from the copy-prohibited medium detecting sensor 66, while taking the input of a document page detection signal output from the document page detecting sensor 68, the CPU 100 brings the reading operation to a stop by controlling the optical system 42 of the document reading device 14. The CPU may stop document page transportation by controlling the automatic document feeding device 44.

In that event, the CPU 100 causes the apparatus to issue an audible alert notifying that a copy-protected medium has been detected. In particular, the CPU controls the loudspeaker 110 to issue such audible alert.

The CPU 100 causes the display 106 to display plural options to handle the detected copy-protected medium, so that a user may select one of the displayed options of handling. After receiving a user-selected option via the input device 108, the CPU performs handling of the document page according to the selected option. The plural options of handling include, for example, aborting the copying of the document page, copying the document page after a certain security action such as password input, copying the document page but with some restriction such as, e.g., hatching imposed on the copied document page content, and others.

The CPU 100 may cause the apparatus to send information about these plural options of handling to a remote terminal device and receive information as to a user selected option via the communication device 104. Once having received a copy prohibition signal, the CPU 100 may reset the copy-prohibited medium detecting sensor 66 after controlling to disable or inhibit the copying of the document page.

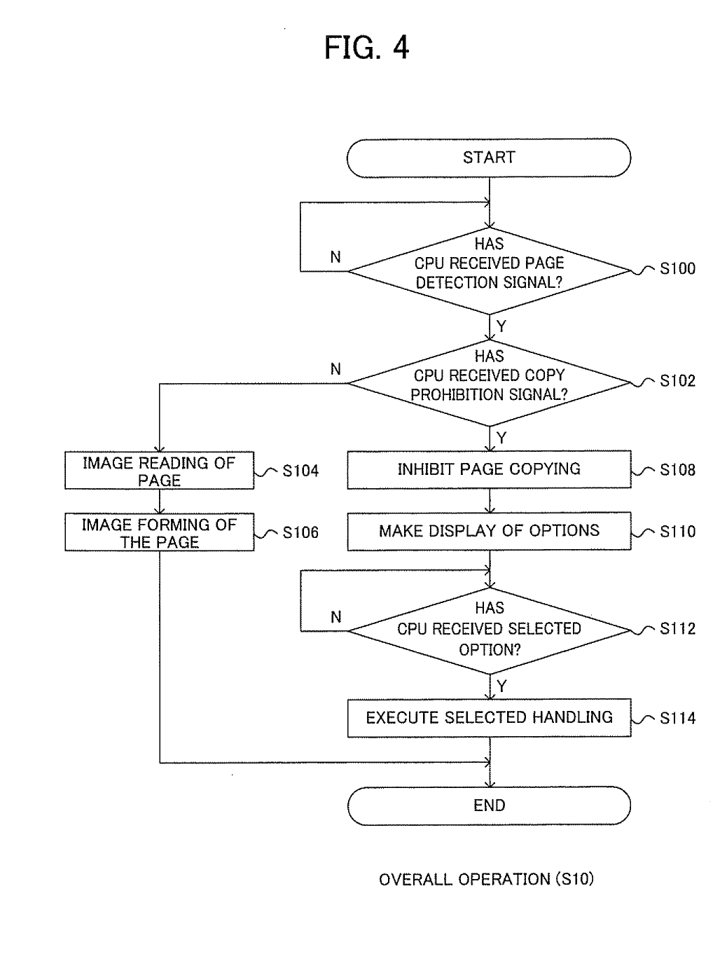

FIG. 4 is a flowchart illustrating an overall operation (S10) of the image forming apparatus 10 according to a first exemplary embodiment of the present invention.

As shown in FIG. 4, at step 100 (S100) the CPU 100 of the controller 60 determines whether it has received a document page detection signal. If the CPU 100 has received a document page detection signal, it goes to step S102; otherwise, it returns to step S100. When the user places a document page or pages on the document mount 56 of the image forming apparatus 10, the document page detecting sensor 68 detects that the document page or pages are set in place and outputs a document page detection signal to the controller 60.

At step 102 (S102), the CPU 100 determines whether it has received a copy prohibition signal. If the CPU 100 has received a copy prohibition signal, it goes to step S108; otherwise it goes to step S104.

If no copy prohibition signal has been received, when a copy command is issued by, for example, pressing a copy button (not shown) by the user, at step 104 (S104), each document page is transported by the automatic document feeding device 44 and read by the optical system 42 and image data is generated.

At step 106 (S106), based on the image data, an image is formed on a sheet transported from the appropriate sheet feed tray 16 or the like by the image forming part 12. Then, the sheet is ejected to the sheet output tray 36.

Otherwise, if a copy prohibition signal has been received, the CPU 100 inhibits the copying at step 108 (S108). In particular, the CPU brings the read operation by the optical system 42 to a stop. Thus, no image data is generated. Also, the CPU 100 issues an audible alert notifying that a copy-protected medium has been detected.

At step 110 (S110), the CPU 100 causes the display 106 to display plural options of handling the detected copy-protected medium.

At step 112 (S112), the CPU 100 determines whether it has received a user-selected option of handling from the plural options. If CPU 100 has received a selected option of handling, it goes to step S114; otherwise, it returns to step S112. The user selects and specifies one of the plural options of handling displayed on the display 106, using the input device 108.

At step 114 (S114), the CPU 100 executes the selected handling.

Next, an image forming apparatus 10 according to a second exemplary embodiment of the invention is described. The image forming apparatus 10 according to the second exemplary embodiment of the invention differs from the image forming apparatus 10 of the first exemplary embodiment in that the copy-prohibited medium detecting sensor 66 detects whether a recording medium of a document page being transported through the document transport path 58 of the automatic document feeding device 44 is a copy-prohibited one.

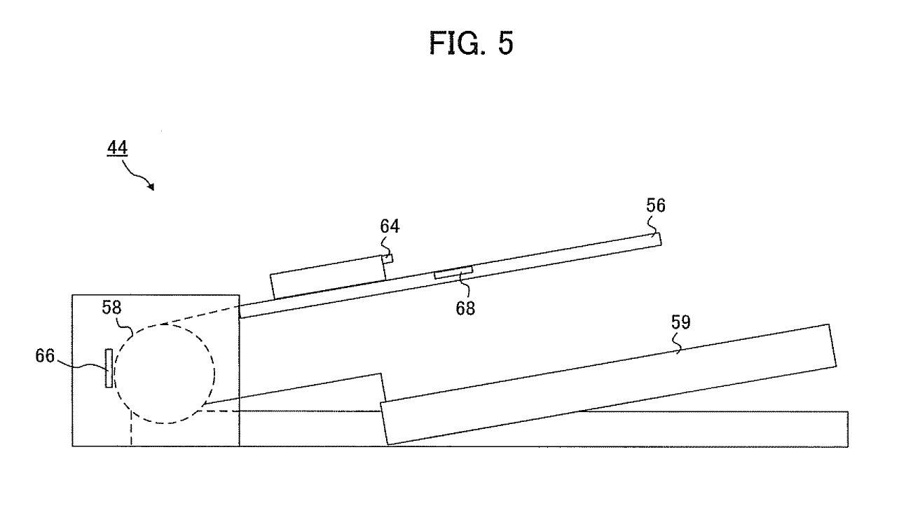

FIG. 5 illustrates a detailed structure of the automatic document feeding device 44 of the image forming apparatus 10 according to the second exemplary embodiment of the invention. The components shown in FIG. 5 that substantially correspond to those shown in FIG. 2 are assigned the same reference numbers.

As shown in FIG. 5, in the image forming apparatus 10 of the present exemplary embodiment, the copy-prohibited medium detecting sensor 66 is provided in the proximity of the document transport path 58 of the automatic document feeding device 44. More specifically, the copy-prohibited medium detecting sensor 66 is located on the document transport path 58, upstream of the optical system 42 of the document reading device 14 and downstream of the document mount 56 and the transport rollers 62 for transporting a document page from the document mount 56.

Thus, the copy-prohibited medium detecting sensor 66 detects a copy-prohibited medium that is transported on the document transport path 58 from the document mount 56, before the document page is read by the optical system 42 of the document reading device 14. In the present exemplary embodiment, the CPU 100 has to controls to disable or inhibit the document page copying only once it has received the input of a copy prohibition signal output from the copy-prohibited medium detecting sensor 66. It does not need to receive the input of a copy prohibition signal, while the input of a document page detection signal occurs.

Next, an image forming apparatus 10 according to a third exemplary embodiment of the invention is described. The image forming apparatus 10 according to the third exemplary embodiment of the invention differs from the image forming apparatus 10 of the first exemplary embodiment in that the copy-prohibited medium detecting sensor 66 detects whether a document page placed on the platen glass 54 is a copy-prohibited one.

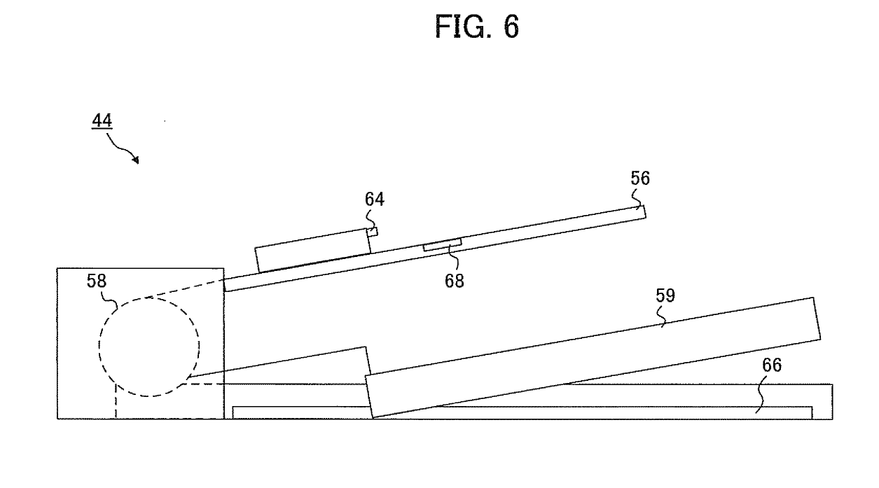

FIG. 6 illustrates a detailed structure of the automatic document feeding device 44 of the image forming apparatus 10 according to the third exemplary embodiment of the invention. The components shown in FIG. 6 that substantially correspond to those shown in FIG. 2 are assigned the same reference numbers.

As shown in FIG. 6, in the image forming apparatus 10 of the present exemplary embodiment, the copy-prohibited medium detecting sensor 66 is provided in the platen cover (the under surface of the automatic document feeding device 44) facing the platen glass 54.

Thus, the copy-prohibited medium detecting sensor 66 detects a copy-prohibited medium placed on the platen glass 54, before the document page is read by the optical system 42 of the document reading device 14. In the present exemplary embodiment as well, the CPU 100 has to control to disable or inhibit the document page copying only once it has received the input of a copy prohibition signal output from the copy-prohibited medium detecting sensor 66. It does not need to receive the input of a copy prohibition signal, while the input of a document page detection signal occurs.

Next, although the image forming apparatus 10 according to a fourth exemplary embodiment is described, a background of the image forming apparatus 10 according to the fourth exemplary embodiment will now be described so as to help understand the present invention.

Since the copy-prohibited medium detecting sensor 66 has a risk of reacting with objects other than a magnetic member embedded in a sheet in error, it reacts with only a sheet and therefore, may be operated only when a sheet is detected. In order to detect the document mounted on the platen cover, it may be permitted to provide the document page detecting sensor in the platen cover or to perform a pre-scan on the document. However, in the case where the document page detecting sensor is provided on the platen cover, since a sheet in all sizes is detected, plural document page detecting sensors should be provided, such that it is difficult to physically provide the copy-prohibited medium detecting sensor. Meanwhile, in the case where the pre-scan is executed, the document is read and image data is generated. As a result, a configuration may be adopted where the document page sensor is not provided on the platen cover.

The image forming apparatus 10 according the fourth exemplary embodiment of the present invention is different from the image forming apparatus 10 according to the first exemplary embodiment in that the copy-prohibited medium detecting sensor 66 detects that the document mounted on the document mount 56 is copy-prohibited as well as the document mounted on the platen cover 54 is copy-prohibited.

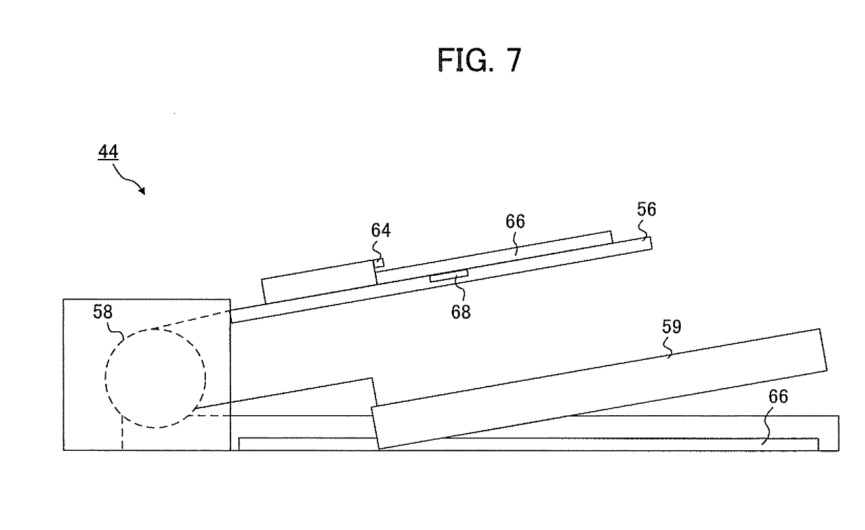

FIG. 7 is a view illustrating a detailed configuration of the automatic document feeding device 44 of the image forming apparatus 10 according to the fourth embodiment of the present invention. Also, among the components shown in FIG. 7, the substantially same components as the components shown in FIG. 2 are denoted by the same reference numerals.

As shown in FIG. 7, in the image forming apparatus 10 according to the fourth embodiment, the copy-prohibited medium detecting sensor 66 is provided on the document mount 56 and the platen cover facing the platen glass 54.

As a result, the copy-prohibited medium detecting sensor 66 is mounted on the document mount 56 or the platen glass 54 to detect the copy-prohibited document before the document is read by the optical system 42 of the document reading device 14. The copy-prohibited medium detecting sensor 66 is mounted on the document mount 56 and the platen glass 54 as a separate antenna. Although an offset value and an amplification rate of a signal, which are detected by the antenna, are set independently, they may be permitted to be set by different circuits and the same circuit.

Further, in the fourth exemplary embodiment, the CPU 100 receives a copy prohibition signal from the copy-prohibited medium detecting sensor 66 mounted on the platen cover as representing that the document is placed on the platen glass 54 within a predetermined time from time detecting that the platen cover is closed, in the case where the document page detecting sensor 68 detects that there is no document on the document mount 56 and the angle sensor (not shown) mounted on the platen cover detects that the platen cover is closed. The CPU 100 receives the copy prohibition signal from the copy-prohibited medium detecting sensor 66 mounted on the document mount 56, in the case where a predetermined time from time detecting that the platen cover is closed has passed. According to the configuration, the copy-prohibited medium detecting sensors 66 mounted on the document mount 56 and the platen cover 54 are switched, such that it can detect the copy-prohibited medium mounted on the document mount 56 or the platen glass 54.

Although the foregoing description describes that the copy-prohibited medium detecting sensor 66 is mounted on the document mount 56 and the platen cover to detect that the document mounted on the document mount 56 and the document mounted on the platen glass 54 are copy-prohibited, the copy-prohibited medium detecting sensor 66 is mounted near the document transport path 58 and on the platen cover, and therefore, may also be permitted to detect that the document transported to the document transport path 58 and the document mounted on the platen glass 54 are copy-prohibited.

Further, although the foregoing description explicitly describes that the copy-prohibited medium detecting sensors 66, which are mounted on the document mount 56 and the platen cover, are switched, a receiving unit (not shown), which receives the copy prohibition signal from the copy-prohibited medium detecting sensor 66 on the document mount 56 and a receiving unit (not shown), which receives the copy prohibition signal from the copy-prohibited medium detecting sensor 66 on the platen cover may be connected to each other in parallel, such that when the CPU 100 receives the copy prohibition signal, the CPU 100 controls to prohibit copying of the document regardless of whether the copy prohibition signal is output from any of the copy-prohibited medium detecting sensor 66.

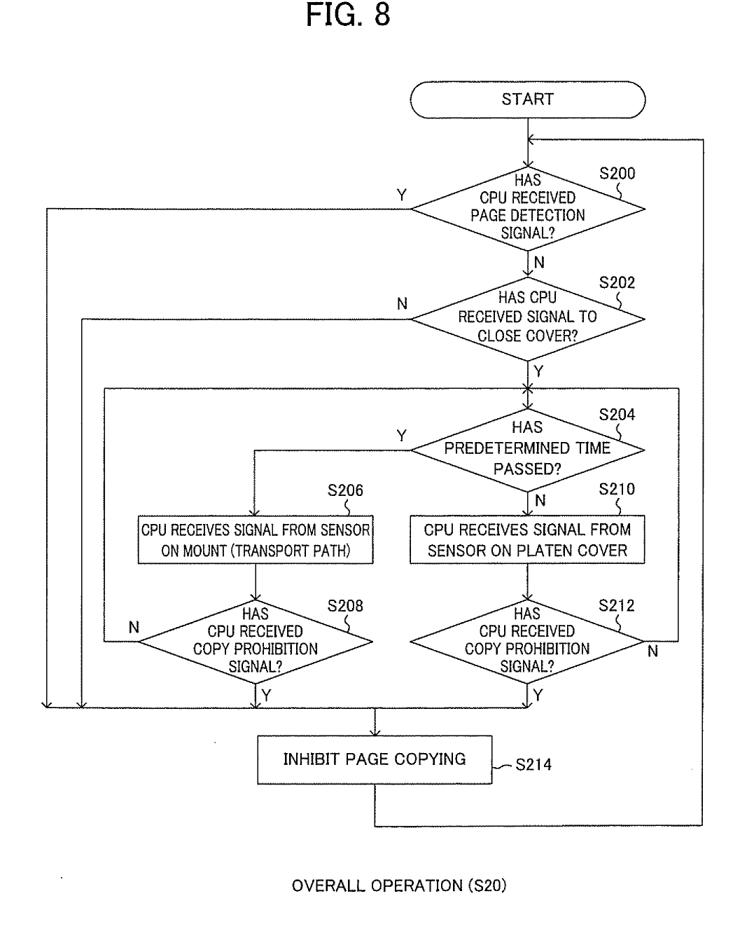

FIG. 8 is a flowchart illustrating an overall operation (S20) of the imaging forming apparatus 10 according to the fourth exemplary embodiment of the present invention.

As shown in FIG. 8, at step 200 (S200), the CPU 100 of the controller 60 determines whether the document page detection signal is received from the document page detecting sensor 68 that is mounted on the document mount 56. If the document page detection signal is received, the CPU 100 proceeds to a process of S214 and if not, proceeds to a process of S202. Like S100 as described above, when a user places the document on the document mount 56 of the image forming apparatus 10, the document page detecting sensor 68 detects the document and outputs the document page detection signal to the controller 60.

At step 202 (S202), the CPU 100 determines whether a signal, which closes the platen cover, is received from the angle sensor mounted on the platen cover. If the signal, which closes the platen cover, is received, the CPU 100 proceeds to a process of S204 and if not, proceeds to the process of S214. When a user closes the platen cover, the angle sensor detects that the platen cover is closed and outputs the signal, which closes the platen cover, to the controller 60.

At step 204 (S204), the CPU 100 determines whether a predetermined time from the time when the platen cover is closed has passed If the predetermined time from the time when the platen cover is closed has passed, the CPU 100 proceeds to a process of S206 and if not, proceeds to a process of S210. For example, the CPU 100 starts a timer when detecting that the platen cover is closed and measures an elapsed time from the time when the platen cover is closed.

At step 206 (S206), the CPU 100 receives the copy prohibition medium signal from the copy-prohibited medium detecting sensor 66 that is mounted on the document mount 56 (or near the document transport path 58) and at step 208 (S208), the CPU 100 determines whether the copy prohibition medium signal is input from the copy-prohibited medium detecting sensor 66 that is mounted on the document mount 56 (or near the document transport path 58). If the copy prohibition medium signal is input, it proceeds to the process of S214 and if not, it is return to the process of S204.

At step 210 (S210), the CPU 100 receives the copy prohibition medium signal from the copy-prohibited medium detecting sensor 66 that is mounted on the platen cover and at step 212 (S212), the CPU 100 determines whether the copy prohibition medium signal is input from the copy-prohibited medium detecting sensor 66 that is mounted on the platen cover. If the copy prohibition medium signal is input, it proceeds to the process of S214 and if not, it is return to the process of S204.

At step 214 (S214), the CPU 100 executes the copy prohibition process. Like S108 as described above, in detail, the CPU 100 stops the reading operation by the optical system 42 and does not generate the image data. Further, like S108 as described above, the CPU 100 may also be permitted to issue an audible alert notifying that the copy-prohibited sheet is detected.

The CPU 100 is returned to a process of S200 when the copy prohibition process ends. Also, like steps S110 through 114 as described above, when the copy prohibition process ends, the CPU executes a process on a copy-prohibited sheet that is detected and may be permitted to return to the process of S200.

The present invention may be embodied in other specific forms without departing from its spirit or characteristics. The described exemplary embodiments are to be considered in all respects only as illustrated and not restrictive. The scope of the invention is, therefore, indicated by the appended claims rather than by the foregoing description. All changes which come within the meaning and range of equivalency of the claims are to be embraced within their scope.

What is claimed is:

1. An image forming apparatus comprising:
an image reading unit that reads an image formed on a recording medium;
a copy-prohibited medium detecting unit that detects whether a recording medium is a copy-prohibited medium; and
a controller that controls to disable or inhibit copying of an image formed on a recording medium, when it is detected by the copy-prohibited medium detecting unit that the recording medium is the copy-prohibited medium, before the image on the recording medium is read by the image reading unit.

2. The image forming apparatus according to claim 1, wherein the copy-prohibited medium detecting unit detects whether the recording medium is the copy-prohibited medium by sensing magnetization inversion induced by a magnetic element included in a recording medium.

3. The image forming apparatus according to claim 1, further comprising a mount part on which a recording medium is placed before being transported so that an image thereon is read by the image reading unit,
wherein the copy-prohibited medium detecting unit is provided in the mount part.

4. The image forming apparatus according to claim 2, further comprising a mount part on which a recording medium is placed before being transported so that an image thereon is read by the image reading unit,
wherein the copy-prohibited medium detecting unit is provided in the mount part.

5. The image forming apparatus according to claim 3, further comprising a recording medium detecting unit that detects a recording medium placed on the mount part,
wherein the controller controls to disable or inhibit copying of an image on the recording medium, when it is detected by the copy-prohibited medium detecting unit that the recording medium is the copy-prohibited medium, while the recording medium is detected by the recording medium detecting unit.

6. The image forming apparatus according to claim 4, further comprising a recording medium detecting unit that detects a recording medium placed on the mount part,
wherein the controller controls to disable or inhibit copying of an image on the recording medium, when it is detected by the copy-prohibited medium detecting unit that the recording medium is the copy-prohibited medium, while the recording medium is detected by the recording medium detecting unit.

7. The image forming apparatus according to claim 1, further comprising a transport path for transporting a recording medium whose image is to be read by the image reading unit,
wherein the copy-prohibited medium detecting unit is provided on the transport path.

8. The image forming apparatus according to claim 2, further comprising a transport path for transporting a recording medium whose image is to be read by the image reading unit,
wherein the copy-prohibited medium detecting unit is provided on the transport path.

9. The image forming apparatus according to claim 1, further comprising a platen glass on which a recording medium whose image is to be read by the image reading unit is placed,
wherein the copy-prohibited medium detecting unit is provided in a platen cover facing the platen glass.

10. The image forming apparatus according to claim 2, further comprising a platen glass on which a recording medium whose image is to be read by the image reading unit is placed,
wherein the copy-prohibited medium detecting unit is provided in a platen cover facing the platen glass.

11 The image forming apparatus according to claim 5,
wherein the copy-prohibited medium detecting unit includes:
a first copy-prohibited medium detecting unit that is provided in the mount part or the transport path for transporting the recording medium provided in the mount part to detect whether the recording medium is the copy-prohibited recording medium; and
a second copy-prohibited medium detecting unit that is provided in the platen cover to detect that whether the recording medium is the copy-prohibited recording medium, and wherein
the recording medium detecting unit is provided in the mount part, and
in the case where the recording medium is not detected by the recording medium detecting unit while the platen cover is closed, the controller controls to prohibit copying of an image on a recording medium, when it is detected by the second copy-prohibited medium detecting unit that the recording medium is the copy-prohibited medium, within a predetermined time from the time when the platen cover is closed, in the case where the recording medium is not detected by the recording medium detecting unit and the platen cover is closed.

12. The image forming apparatus according to claim 6,
wherein the copy-prohibited medium detecting unit includes:
a first copy-prohibited medium detecting unit that is provided in the mount part or the transport path for transporting the recording medium provided in the mount part to detect whether the recording medium is the copy-prohibited recording medium; and
a second copy-prohibited medium detecting unit that is provided in the platen cover to detect whether the recording medium is the copy-prohibited recording medium, and wherein
the recording medium detecting unit is provided in the mount part, and
in the case where the recording medium is not detected by the recording medium detecting unit and the platen cover is closed, the controller controls to prohibit copying of an image on a recording medium, when it is detected by the second copy-prohibited medium detecting unit that the recording medium is the copy-prohibited medium within a predetermined time from the time when the platen cover is closed, in the case where the recording medium is not detected by the recording medium detecting unit and the platen cover is closed.

13. The image forming apparatus according to claim 11, wherein the controller controls to prohibit copying of an image on the recording medium, when it is detected by the first copy-prohibited medium detecting unit that the recording medium is the copy-prohibited medium, after the predetermined time from the time when the platen cover is closed has passed.

14. The image forming apparatus according to claim 12, wherein the controller controls to prohibit copying of an image on the recording medium, when it is detected by the first copy-prohibited medium detecting unit that the recording medium is the copy-prohibited medium, after the predetermined time from the time when the platen cover is closed has passed.

15. The image forming apparatus according to claim 13 wherein, when the controller controls to disable or inhibit copying of an image on the recording medium, the controller executes handling of the recording medium, selected from a plurality of options of handling the recording medium.

16. The image forming apparatus according to claim 14 wherein, when the controller controls to disable or inhibit copying of an image on the recording medium, the controller executes handling of the recording medium, selected from a plurality of options of handling the recording medium.

17. The image forming apparatus according to claim 15, further comprising an alert unit that issues an audible alert notifying that a copy-prohibited recording medium has been detected by the first copy-prohibited medium detecting unit in case of such detection.

18. The image forming apparatus according to claim 16, further comprising an alert unit that issues an audible alert notifying that a copy-prohibited recording medium has been detected by the first copy-prohibited medium detecting unit in case of such detection.

19. An image forming method employed in an image forming apparatus including: a mount part that accommodates a recording medium; a transport path for feeding out the recording medium from the mount part and transporting the recording medium; an image reading unit including a platen cover, the image reading unit reading an image formed on a recording medium; an image forming unit; a transfer unit; and a fixing unit, the image forming method comprising:
detecting whether a recording medium is a copy-prohibited medium, the detecting step comprising first detection performed at the mount part or the transport path, and second detection performed at the platen cover;
detecting a recording medium placed on the mount part;
in the case where a recording medium is not detected on the mount part while the platen cover is closed, controlling to prohibit copying of an image on a recording medium when it is detected in the second detection, within a predetermined time from the time when the platen cover is closed, that the recording medium is the copy-prohibited medium; and
reading an image on a recording medium when it is detected in the second detection that the recording medium is not the copy-prohibited medium.
